(19) United States
(12) Patent Application Publication
(10) Pub. No.: US 2026/0118819 A1
(43) Pub. Date: Apr. 30, 2026

(54) IMAGE FORMING APPARATUS

(71) Applicant: CANON KABUSHIKI KAISHA, Tokyo (JP)

(72) Inventor: YUSUKE NAKASHIMA, Kanagawa (JP)

(21) Appl. No.: 19/364,810

(22) Filed: Oct. 21, 2025

(30) Foreign Application Priority Data
Oct. 29, 2024 (JP) 2024-190141

(51) Int. Cl. G03G 21/16; G03G 15/00; G03G 15/20

(52) U.S. Cl. CPC G03G 21/1647; G03G 15/2053; G03G 15/2064; G03G 15/80; G03G 21/1619; G03G 21/1652; G03G 2215/2035; G03G 2221/1654

(57) ABSTRACT

An image forming apparatus includes a main body, and a fixing apparatus configured to fix toner and including a heating unit, a torsion coil spring having a first arm and a second arm and being conductive and electrically connected to the heating unit, wherein the heating unit is supported by a frame, a front end of an end portion of the first arm is in contact with a contact surface of a main-body conductor portion, the main-body conductor portion includes a main-body upstream end in a mounting direction, when the end portion starts making contact with the main-body upstream end, the end portion extends in a first direction as the end portion is moved toward the mounting direction, the front end in contact with the contact surface is guided to the contact surface and subsequently moves in the mounting direction.

### BACKGROUND

### Field of the Technology

The present disclosure relates to an electrophotographic image forming apparatus.

### DESCRIPTION OF THE RELATED ART

A fixing apparatus discussed in Japanese Patent Laid-Open No. 2024-31208 includes a heating unit and a pressing roller and fixes toner on a recording material. The heating unit includes a heater configured to heat an inner surface of a belt, and the pressing roller forms a nip portion with the heater via the belt.

### SUMMARY

The present disclosure is directed to providing a fixing apparatus of a new type based on conventional technology.

An aspect of the present disclosure provides an image forming apparatus that includes a main body including a main-body conductor portion configured to be grounded and a fixing apparatus configured to mount on the main body by moving the fixing apparatus in a mounting direction relative to the main body to a mounting position. The fixing apparatus includes a heating unit and a heater configured to heat an inner surface of the belt, with a longitudinal direction of the heating unit intersecting with the mounting direction. The fixing apparatus also includes a conductive torsion coil spring including a coil portion, a first arm extending from the coil portion to an upstream side in the mounting direction, and a second arm extending from the coil portion to a downstream side in the mounting direction, the conductive torsion coil spring being electrically connected to the heating unit. The fixing apparatus also includes a frame configured to support the heating unit and the coil portion. A front end portion of the first arm is configured to contact a contact surface of the main-body conductor portion. The main-body conductor portion includes an upstream end connected to the contact surface along the mounting direction. The longitudinal direction extending from the conductive torsion coil spring to a longitudinal center of the heating unit is a first direction, and a direction opposite to the first direction is a second direction. In response to moving the fixing apparatus toward the mounting position, the second arm is pressed by the upstream end. The first arm is configured to move in the second direction so that the front end portion is brought into contact with the upstream end, when the second arm moves in the first direction. When the front end portion initiates contact with the upstream end and moves in the mounting direction, the front end portion is configured to extend in the first direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views illustrating a fixing apparatus according to an embodiment.

FIG. 2 is a cross-sectional view illustrating the fixing apparatus according to an embodiment.

FIG. 3 is a cross-sectional view illustrating the fixing apparatus according to an embodiment.

FIG. 4 is a cross-sectional view illustrating the fixing apparatus according to an embodiment.

FIG. 5 is an exploded perspective view illustrating the fixing apparatus according to an embodiment.

FIGS. 6A and 6B are perspective views illustrating the fixing apparatus according to a first embodiment.

FIG. 7 is a top view illustrating the fixing apparatus according to the first embodiment.

FIG. 8 is a perspective view illustrating the fixing apparatus according to the first embodiment.

FIG. 9 is a cross-sectional view illustrating the fixing apparatus according to the first embodiment.

FIGS. 10A and 10B are front and plan views illustrating a contact spring according to the first embodiment.

FIGS. 11A, 11B, 11C, and FIG. 11D are front and cross-sectional views illustrating the fixing apparatus according to the first embodiment.

FIGS. 12A and 12B are cross-sectional views illustrating the fixing apparatus according to the first embodiment.

FIG. 13 is an exploded perspective view illustrating the fixing apparatus according to the first embodiment.

FIGS. 14A and 14B are front and plan views illustrating the contact spring according to the first embodiment.

FIG. 15 is a plan view illustrating the fixing apparatus according to the first embodiment.

FIG. 16 is a plan view illustrating the fixing apparatus according to the first embodiment.

FIG. 17 is a plan view illustrating the fixing apparatus according to the first embodiment.

FIG. 18 is a plan view illustrating the fixing apparatus according to the first embodiment.

FIG. 19 is a plan view illustrating a fixing apparatus according to a second embodiment.

FIG. 20 is a plan view illustrating the fixing apparatus according to the second embodiment.

FIG. 21 is a plan view illustrating the fixing apparatus according to the second embodiment.

FIG. 22 is a plan view illustrating a contact spring according to a modification example.

### DETAILED DESCRIPTION

### First Embodiment

Embodiments of the present disclosure will be described with reference to the drawings. Dimensions, materials, shapes, relative positions, and the like of components described in the following embodiments can be changed as necessary depending on a configuration of an apparatus to which the present disclosure is applied, various conditions, or the like. Accordingly, unless otherwise specified, the scope of the present disclosure is not limited to the embodiments.

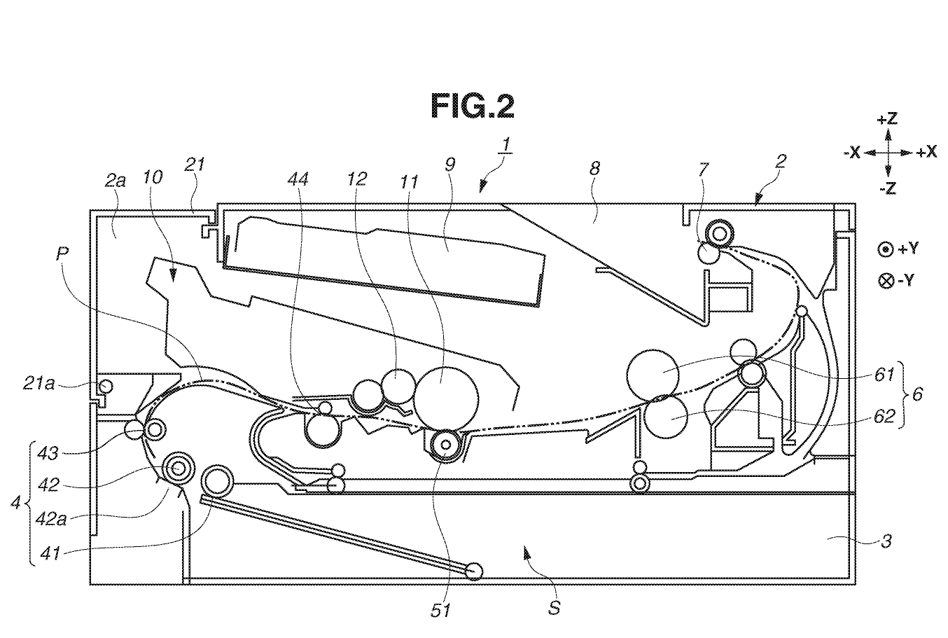

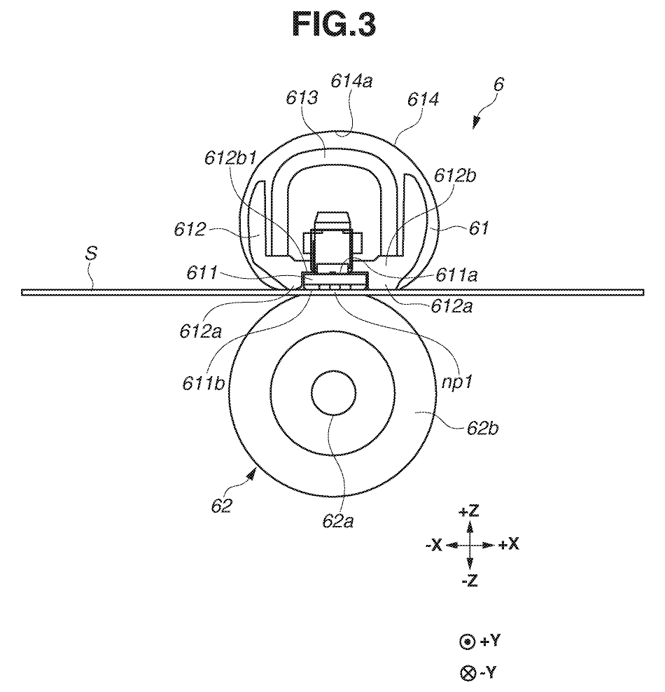

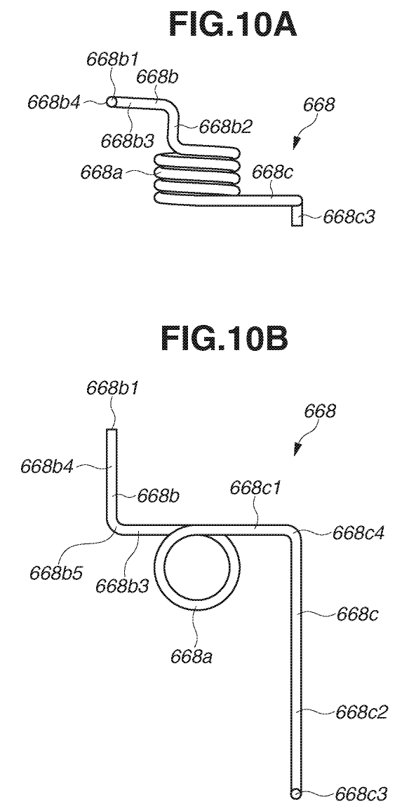

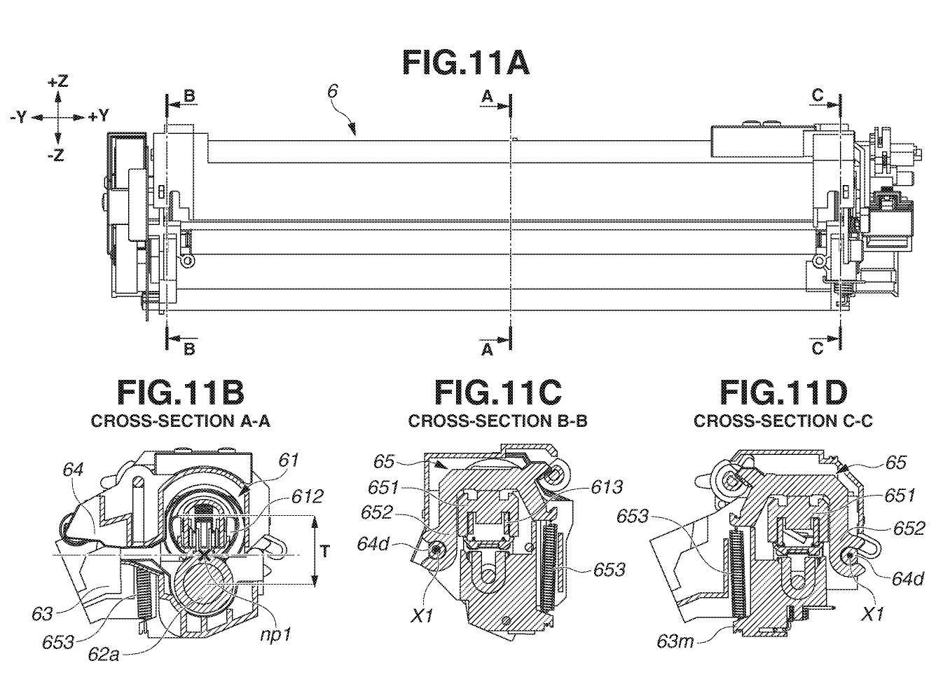

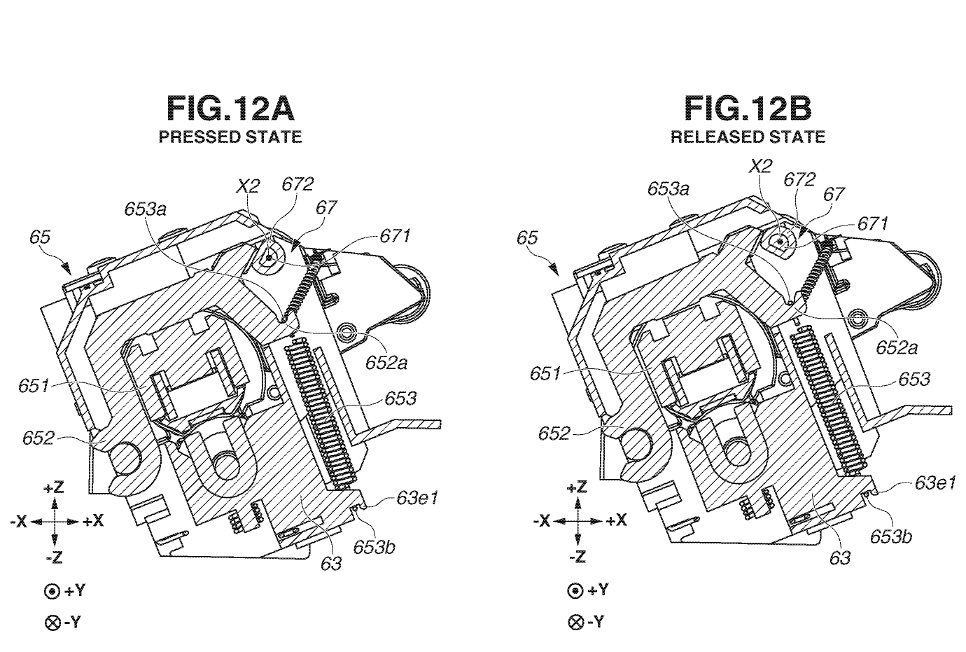

FIG. 2 is a cross-sectional view illustrating an electrophotographic image forming apparatus 1 to which a fixing device according to the embodiments is applied. In the following description, as illustrated in FIG. 2, a vertical direction in a case where the image forming apparatus 1 is positioned on a horizontal surface is the Z direction. As also illustrated, the direction that intersects with the Z direction is the Y direction. The Y direction is a direction that is parallel to a rotational axis direction of a pressing arm 652 (FIGS. 11C-12B). As further illustrated, the direction that intersects with both the Z and Y directions is the X direction. The X direction is a direction that is parallel to a direction in which a heating unit 61, which will be described below, conveys a recording material positioned at a nip portion np1 (FIGS. 3, 4, 11B). The X and Y directions can be horizontal directions. Further, the X, Y, and Z directions can be perpendicular to each other. As necessary, directions of arrows X, Y, and Z illustrated in the drawings will be referred to as +X, +Y, and +Z sides, respectively, and the opposite directions will be referred to as –X, –Y, and –Z sides, respectively. Hereinafter, a direction in which a recording material at a nip portion np1, which will be described below, is conveyed will be referred to as a recording material conveyance direction (+X direction). Further, the +X direction is a mounting direction in which a fixing apparatus 6, as described below, is mounted on a main body 2 of the image forming apparatus 1, may also be referred to as a mounting direction. The rotational axis direction of the pressing arm 652, as described below, will be referred to as axial direction. A direction from the heating unit 61, as described below, toward an electrical contact point 668b1 (FIG. 10A) in the axial direction will be referred to as a first axial direction (+Y direction). A direction that is opposite to the first axial direction in the axial direction will be referred to as a second axial direction (-Y direction). The Y direction is a longitudinal direction of the heating unit 61. Further, the Y direction is a generatrix direction of a belt 614 (FIGS. 3, 5, 9). Further, the longitudinal direction of the heating unit 61 from a contact spring 668 (FIGS. 10A, 10B, 14-22) toward a longitudinal center of the heating unit 61 will be referred to as first direction (-Y direction).

### Configuration of the Image Forming Apparatus

A configuration of the image forming apparatus 1 will be described with reference to FIG. 2. The image forming apparatus 1 includes the main body 2 of the image forming apparatus 1, a process cartridge 10, and the fixing apparatus 6. The process cartridge 10 is removably mounted on the main body 2 of the image forming apparatus 1. The fixing apparatus 6 is removably mounted on the main body 2 of the image forming apparatus 1. Thus, the fixing apparatus 6 is installed in the main body 2 of the image forming apparatus 1. The fixing apparatus 6 may be mounted so that the fixing apparatus 6 cannot be removed from the main body 2.

The main body 2 of the image forming apparatus 1 includes a sheet feed tray 3, a sheet feed unit 4, a conveyance path P, a transfer roller 51, a sheet discharge portion 7, a sheet discharge tray 8, a laser scanner 9, and an opening/closing door 21. The process cartridge 10 includes a photosensitive drum 11 and a development roller 12 as a developer bearing member. Further, the process cartridge 10 contains a developer. The opening/closing door 21 is supported so that the opening/closing door 21 can pivot around a pivot shaft 21a, and is configured to move between a closed position, at which an opening portion 2a is closed, and an open position, at which the opening portion 2a is opened. In a case where the opening/closing door 21 is at the open position and the opening portion 2a is opened, the process cartridge 10 can be mounted on or removed from the main body 2 of the image forming apparatus 1 through the opening portion 2a.

The sheet feed unit 4 is composed of a sheet feeding roller 41, a separating roller 42, a separating pad 42a, and a conveyance roller pair 43. Based on a print start signal, a sheet S stored in the sheet feed tray 3 is fed into the conveyance path P by the sheet feed unit 4 and conveyed through a registration roller pair 44 toward the transfer roller 51.

When the sheet S is conveyed to a predetermined position, an image forming start signal is issued, and an image forming process is started. The photosensitive drum 11 driven and rotated by a drive source (motor), which is not illustrated, is uniformly charged to a predetermined potential by a charging unit, which is not illustrated. The laser scanner 9 exposes the charged surface of the photosensitive drum 11 based on image information, thereby forming an electrostatic image from which the charge in the exposure portion has been removed. Toner in the process cartridge 10 is borne by the development roller 12, supplied to the photosensitive drum 11 based on an electrostatic latent image, and develops the latent image. Consequently, the latent image is visualized as a toner image on the photosensitive drum 11.

The transfer roller 51 is positioned to face the photosensitive drum 11 of the process cartridge 10. When the sheet S conveyed by the registration roller pair 44 passes through a nip between the photosensitive drum 11 and the transfer roller 51, voltage from the main body 2 of the image forming apparatus 1 is applied to the transfer roller 51, thereby transferring the toner image on the photosensitive drum 11 onto the sheet S as an unfixed image. Subsequently, the sheet S to which the toner image has been transferred is conveyed to the fixing apparatus 6, which includes the heating unit 61 and a pressing rotation member 62. The fixing apparatus 6 is configured to fix the toner (developer) to a recording material. When the sheet S passes through a nip between the heating unit 61 and the pressing rotation member 62, heat and pressure are applied to the transferred unfixed image on the sheet S, thereby fixing the image onto the surface of the sheet S. The sheet S to which the toner image has been fixed is conveyed through the sheet discharge portion 7 and discharged to the sheet discharge tray 8.

### Configuration of the Fixing Device

A configuration of the fixing device will be described. FIG. 3 is a plan view illustrating the fixing apparatus 6. As illustrated in FIG. 3, the heating unit 61 includes a heater 611, a holder 612, a stay 613, and the belt 614. The heater 611 is positioned on the inside of the belt 614 and heats the belt 614. The heater 611 extends along the generatrix direction (Y direction) of the belt 614 and has a flat, plate-like shape. The heater 611 includes a first surface 611a and a second surface 611b on the opposite side of the first surface 611a. The first surface 611a is supported by the holder 612.

The holder 612 is made of a heat-resistant resin, such as polyphenylene sulfide (PPS) or liquid crystal polymer, and includes a guide surface 612a and a supporting wall 612b. The guide surface 612a is in contact with an inner peripheral surface 614a of the belt 614 and guides the belt 614, and the supporting wall 612b includes a supporting surface 612b1 configured to support the heater 611. The supporting surface 612b1 of the supporting wall 612b is in contact with the first surface 611a of the heater 611. The stay 613 is configured to support the holder 612 and is formed by bending a plate material having a greater stiffness than the holder 612, such as a steel plate having a thickness of 1.6 mm, into a substantially U-shaped form.

The belt 614 is a heat-resistant, flexible, endless belt formed by, for example, coating a metal sleeve, such as stainless steel, with a fluoropolymer, or layering polyimide resin, silicone rubber, fluoropolymer, and the like. The heater 611, the holder 612, and the stay 613 are positioned inside the belt 614, and the belt 614 is configured to rotate around the heater 611, the holder 612, and the stay 613. The inner peripheral surface 614a of the belt 614 is brought into contact with the second surface 611b of the heater 611.

The pressing rotation member 62 (pressing roller) includes a shaft 62a and a roller 62b and is pressed against the heater 611 via the belt 614. The shaft 62a is made of metal, and the roller 62b is made of elastic material coating the shaft 62a. The pressing rotation member 62 and the heater 611 sandwich the belt 614, thereby forming the nip portion np1 to nip the sheet S and apply heat and pressure to the sheet S. In other words, the pressing rotation member 62 and the heater 611 together form the nip portion np1 via the belt 614. That is to say, the pressing rotation member 62 and the heater 611 press together to apply heat and pressure to the sheet S at the nip portion np1.

The pressing rotation member 62 is configured to rotate when a driving force from a drive source of the image forming apparatus 1 is transmitted to the pressing rotation member 62. As the pressing rotation member 62 rotates, the belt 614 is driven to rotate. The sheet S to which the toner image has been transferred is conveyed between the pressing rotation member 62 and the belt 614 to which heat has been applied, thereby thermally fixing the toner image.

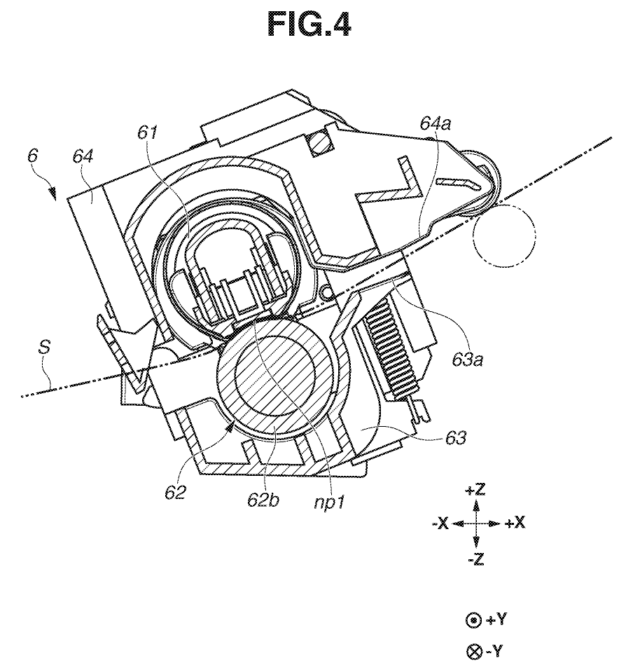

Next, a frame configuration of the fixing apparatus 6 will be described with reference to FIG. 4. FIG. 4 is a plan view illustrating the fixing apparatus 6. The fixing apparatus 6 includes an upper frame 64 and a lower frame 63. The lower frame 63 may also be referred to as a first frame and the upper frame 64 as a second frame. The lower frame 63 supports the heating unit 61 and the pressing rotation member 62. The upper frame 64 is positioned above the lower frame 63 and covers the heating unit 61. The lower frame 63 and the upper frame 64 are made of resin and formed using a non-conductive mold member (resin member). The upper frame 64 includes an upper guide surface 64a positioned downstream of the heating unit 61 in the recording material conveyance direction (+X). The upper guide surface 64a guides an upper surface of the sheet S conveyed in the recording material conveyance direction. The lower frame 63 includes a lower guide surface 63a positioned downstream of the heating unit 61 in the recording material conveyance direction. The lower guide surface 63a guides a lower surface of the sheet S conveyed in the recording material conveyance direction.

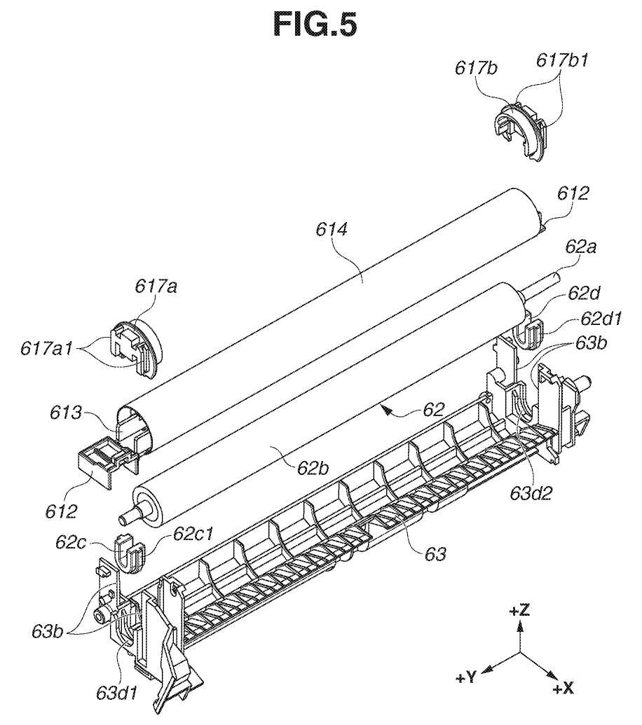

Next, a configuration of the lower frame 63 configured to support the pressing rotation member 62 will be described with reference to FIG. 5, which is an exploded perspective view illustrating a portion of the fixing apparatus 6. The lower frame 63 includes rails 63b at each end portion in the first and second axial directions. The rails 63b extend along the vertical direction and support the holders 612 so that the holders 612 can move along the vertical direction. The two rails 63b face each other in the axial direction. The rails 63b are configured to engage with grooved portions 617a1 and 617b1 of transmission members 617a and 617b.

The fixing apparatus 6 includes a bearing 62c. End portions of the shaft 62a in the first and second axial directions are supported by the bearings 62c and 62d, respectively. The bearing 62c is fitted into a recess 63d1 of the lower frame 63 to achieve positioning. Similarly, the bearing 62d is fitted into a recess 63d2 of the lower frame 63 to achieve positioning. The bearing 62c is electrically conductive. Although the bearings 62c and 62d include protrusions and the lower frame 63 includes the recesses 63d1 and 63d2 in the present configuration, the protrusion-and-recess relationship may be reversed. Further, a unit for securing the bearings 62c and 62d to the lower frame 63 does not have to be the protrusion-and-recess shape.

### Pressing Mechanism Configuration

Next, a configuration of a pressing mechanism of the fixing apparatus 6 will be described. FIG. 11A is a front view illustrating the fixing apparatus 6. FIGS. 11B to 11D are cross-sectional views of FIG. 11A.

As illustrated in FIGS. 11A to 11D, the fixing apparatus 6 includes pressing mechanisms 65 configured to press the heating unit 61 against the pressing rotation member 62. The pressing mechanisms 65 are positioned at end portions of the lower frame 63 in the first and second axial directions. In other words, the pressing mechanisms 65 is supported by the lower frame 63. The pressing mechanism 65 positioned at the end portion of the lower frame 63 in the first axial direction and the pressing mechanism 65 positioned at the end portion of the lower frame 63 in the second axial direction have substantially the same structure. Therefore, the description of the pressing mechanism 65 on the first axial direction side also applies to the pressing mechanism 65 on the second axial direction. Thus, the description of the pressing mechanism 65 on the second axial direction is incorporated by reference herein, for conciseness.

The pressing mechanism 65 includes a transmission member 651, the pressing arm 652, and a pressing spring 653. The pressing arm 652 is supported by the lower frame 63. More specifically, the pressing arm 652 is supported by a support portion 64d of the lower frame 63 so that the pressing arm 652 can pivot around a central axis X1 of the support portion 64d. The support portion 64d is a substantially cylindrical protrusion.

The pressing arm 652 presses the transmission member 651 from above to move the transmission member 651 downward. Consequently, the transmission member 651 presses the stay 613 downward. The transmission member 651 presses the stay 613 to move the stay 613 downward. By moving the stay 613 downward, the heating unit 61, including the stay 613, is pressed toward the pressing rotation member 62. The pressing spring 653 is a conductive tension coil spring configured to urge the pressing arm 652 so that the heating unit 61 is pressed against the pressing rotation member 62. The pressing spring 653 engages with the lower frame 63 and the pressing arm 652. As a result of being urged by the pressing spring 653, the pressing arm 652 moves the transmission member 651 downward. In other words, the pressing arm 652 presses the heating unit 61 against the pressing rotation member 62.

### Configuration of Pressing and Releasing Mechanism

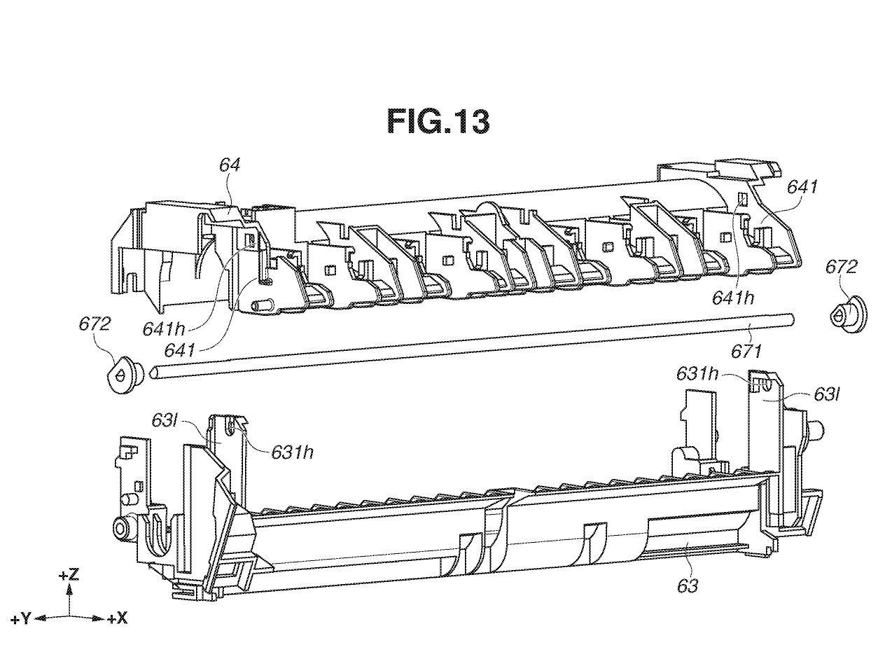

Next, a configuration of a pressing and releasing mechanism of the fixing apparatus 6 will be described with reference to FIGS. 12A, 12B, and 13. FIGS. 12A and 12B are cross-sectional views illustrating the fixing apparatus 6. FIG. 12A illustrates a pressed state where a pressing and releasing mechanism 67 is pressing. FIG. 12B illustrates a released state where the pressing is released by the pressing and releasing mechanism 67. FIG. 13 is an exploded perspective view illustrating the upper frame 64, the lower frame 63, and a camshaft 671, and some heating unit 61 components. For clarity, the pressing rotation member 62 and the like are not illustrated. The pressing and releasing mechanism 67 is a nip pressing and releasing mechanism configured to change a nip pressure at the nip portion np1 between the heating unit 61 and the pressing rotation member 62. The pressing and releasing mechanism 67 includes the camshaft 671 and cams 672.

As illustrated in FIGS. 12A and 12B, the camshaft 671 can pivot around an axis X2. The camshaft 671 extends along the axial direction and is a conductive metal. As illustrated in FIG. 13, the cams 672 are secured to (supported by) end portions of the camshaft 671 in the first and second axial directions. The cams 672 are supported so that the cams 672 pivot together with the camshaft 671. The cams 672 are positioned at end portions of the lower frame 63 in the first and second axial directions. The cam 672 at the end portion of lower frame 63 in the first axial direction and the cam 672 at the end portion of lower frame 63 in the second axial direction have substantially the same structure.

The cams 672 press the pressing arm 652 against the urging force of the pressing spring 653. Specifically, the cams 672 rotate to change the pressing force of the pressing arm 652 that presses the heating unit 61 against the pressing rotation member 62. The cams 672 can pivot between a pressing position illustrated in FIG. 12A and a releasing position illustrated in FIG. 12B.

To release the pressed state, the camshaft 671 is rotated to rotate the cams 672. As the cams 672 rotate, the pressing arm 652 in contact with the cams 672 moves from the transmission member 651 in the opposite direction to the direction in which the stay 613 is pressed by the transmission member 651.

Consequently, the pressure by which the heating unit 61 is pressed against the pressing rotation member 62 decreases.

Next, a support configuration of the camshaft 671 will be described with reference to FIG. 13. The lower frame 63 includes supporting walls 63l configured to support the camshaft 671 so that the camshaft 671 can rotate. The supporting walls 63l extend along the vertical direction (Z direction). The supporting walls 63l include holes 631h to support the camshaft 671 so that the camshaft 671 can pivot. The camshaft 671 is passed through the holes 631h. In other words, the supporting walls 63l can also be referred to as shaft support portions configured to support the camshaft 671. The supporting walls 63l are positioned at end portions of the lower frame 63 in the first and second axial directions. The supporting walls 63l include the holes 631h, which are substantially the same, respectively.

The upper frame 64 includes supporting walls 64l configured to support the camshaft 671 so that the camshaft 671 can pivot.

The supporting walls 64l extend along the vertical direction. The supporting walls 64l include holes 641h to support the camshaft 671 so that the camshaft 671 can pivot. The camshaft 671 is passed through the holes 641h. The supporting walls 64l are positioned at end portions of the upper frame 64 in the first and second axial directions. The supporting walls 64l include the holes 641h, which are substantially the same, respectively.

### Grounding Configuration of the Fixing Device

Next, a grounding configuration of the fixing apparatus 6 will be described. The fixing apparatus 6 according to the present embodiment includes a grounding configuration configured to remove static electricity generated in the heating unit 61 of the fixing apparatus 6. Static electricity generated in the fixing apparatus 6 flows into the main body 2 of the image forming apparatus 1 via a static electricity removing device 66.

### Static Electricity Removing Device

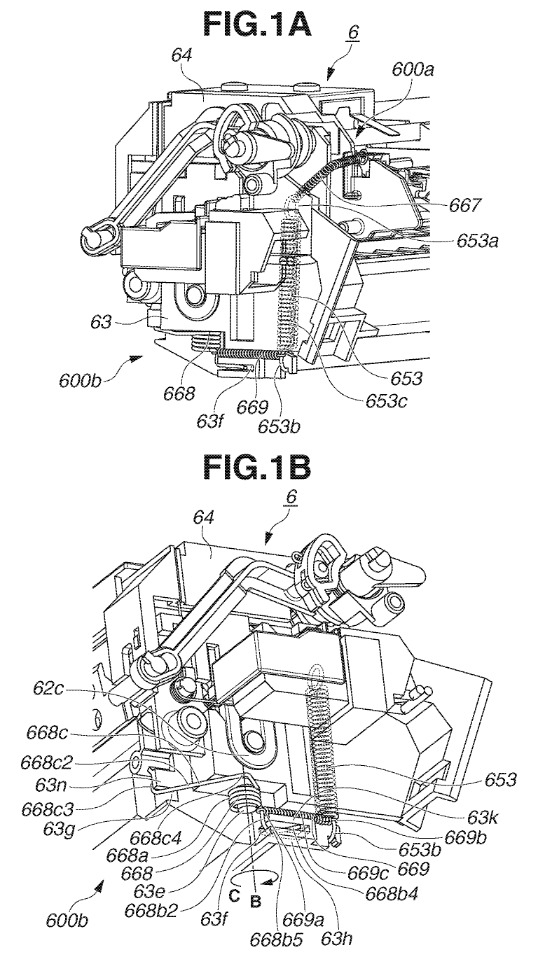

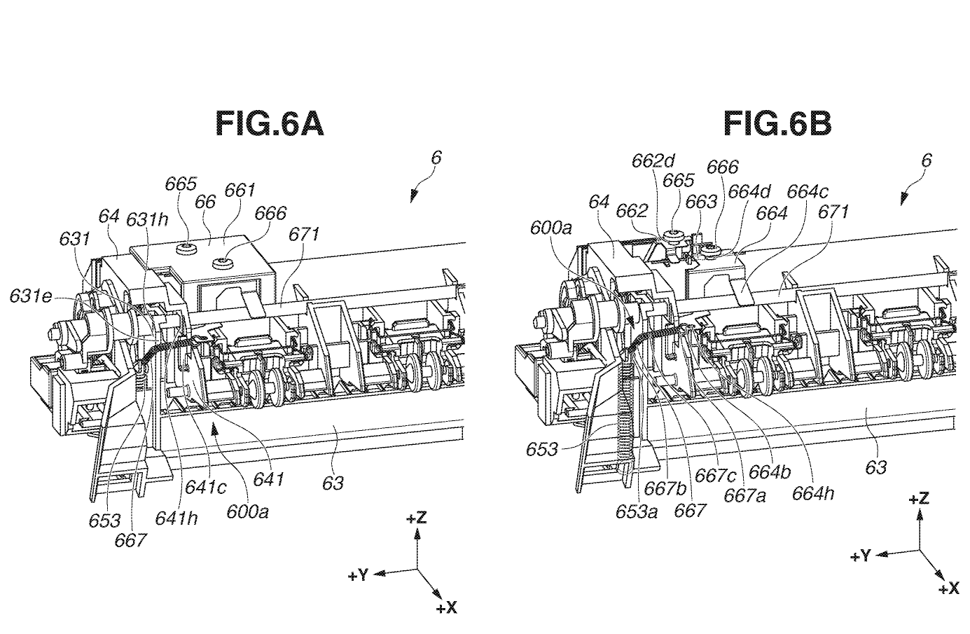

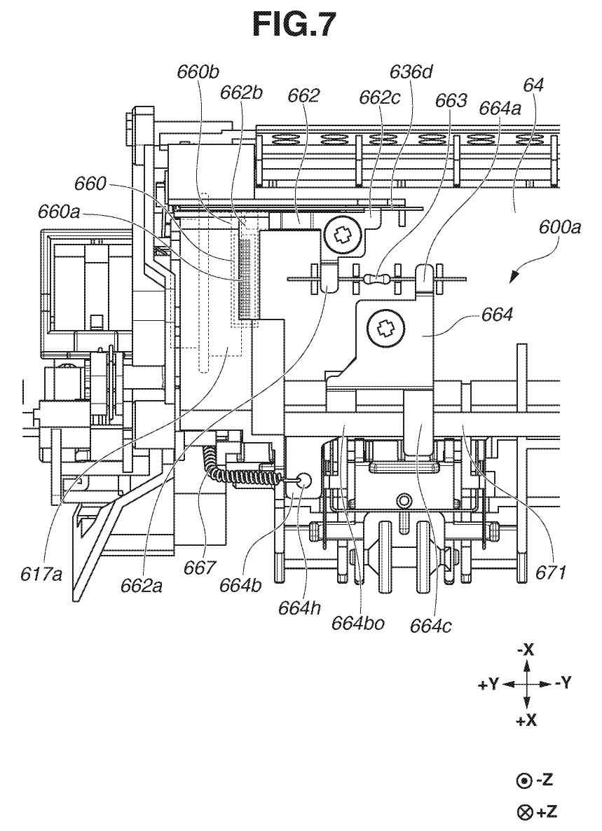

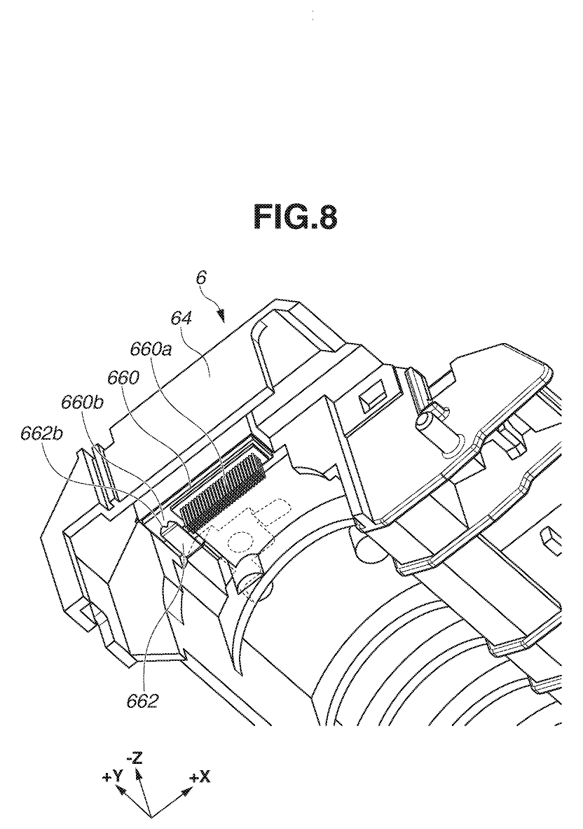

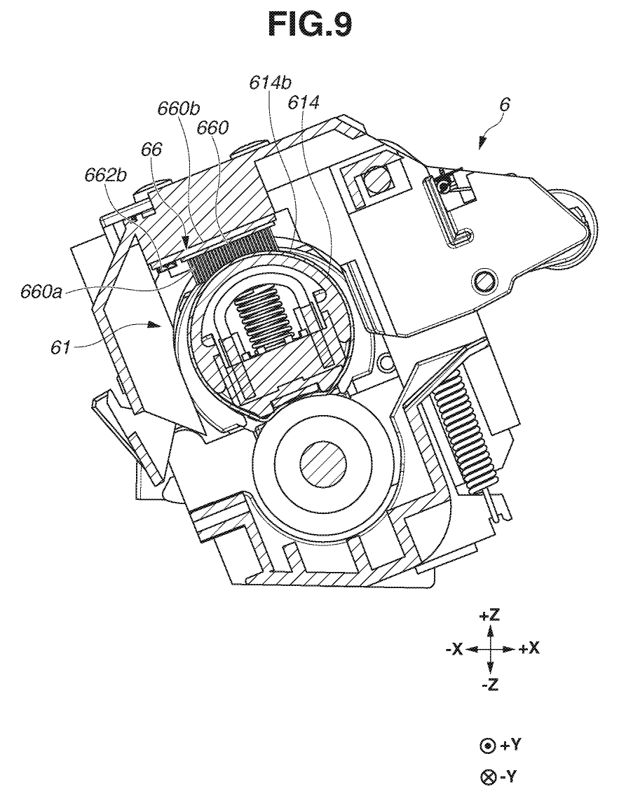

A configuration of the static electricity removing device 66 will be described with reference to FIGS. 1A, 1B, 6A, 6B, 7, 8, and FIG. 9. FIGS. 1A and 1B are perspective views illustrating the fixing apparatus 6. FIG. 6A is a perspective view illustrating the fixing apparatus 6. FIG. 6B is a perspective view illustrating the fixing apparatus 6 without illustrating a cover 661, which is illustrated in FIG. 6A. FIG. 7 is a top view illustrating the fixing apparatus 6. FIG. 8 is a perspective view illustrating the fixing apparatus 6. FIG. 9 is a cross-sectional view illustrating the fixing apparatus 6.

As illustrated in FIG. 6A, the static electricity removing device 66 configured to remove static electricity generated in the fixing apparatus 6 is mounted on the upper frame 64. The static electricity removing device 66 is positioned downstream of a midpoint of the belt 614 in the first axial direction.

As illustrated in FIG. 6A to 9, the static electricity removing device 66 includes a brush 660 (brush member), a first conductive plate 662, a resistance component 663, a second conductive plate 664, the cover 661, screws 665 and 666, and a first conductive spring 667.

The brush 660 is in contact with the heating unit 61 and the first conductive plate 662. The first conductive plate 662 is in contact with the resistance component 663. The second conductive plate 664 is in contact with the first conductive spring 667. Further, the brush 660, the first conductive plate 662, the resistance component 663, and the second conductive plate 664 are conductive. Thus, static electricity generated in the heating unit 61 is transmitted from the brush 660 to the first conductive spring 667.

The cover 661 is configured to cover the brush 660, the first conductive plate 662, and the second conductive plate 664 from above. As illustrated in FIGS. 6A and 6B, the screw 665 secures the first conductive plate 662 together with the cover 661 to the upper frame 64. The screw 666 secures the second conductive plate 664 together with the cover 661 to the upper frame 64.

A configuration of the brush 660 will be described. As illustrated in FIG. 8, the brush 660 is secured inside the upper frame 64. As illustrated in FIG. 9, the brush 660 is a conductive member configured to be brought into contact with the belt 614 from above. The brush 660 includes a main body 660a and a base plate 660b. The main body 660a is made of conductive resin. The base plate 660b is made of stainless steel (SUS), which is a metal and is conductive. The main body 660a of the brush 660 is in contact with a front surface 614b (conductive layer) of the belt 614, and the main body 660a of the brush 660 and the belt 614 are electrically connected. In other words, the brush 660 and the heating unit 61 are electrically connected. Although the main body 660a of the brush 660 is in contact with the front surface 614b of the belt 614 in the present embodiment, a conductive member may be placed between the main body 660a and the belt 614 so that the main body 660a and the belt 614 are electrically connected. The base plate 660b is secured to the main body 660a of the brush 660 and the upper frame 64. In other words, the main body 660a of the brush 660 is secured to the upper frame 64 via the base plate 660b. As illustrated in FIG. 8, the base plate 660b is in contact with a contact portion 662b, as described below, of the first conductive plate 662. In other words, the base plate 660b and the first conductive plate 662 are electrically connected. As illustrated in FIG. 7, the main body 660a of the brush 660 is in contact with the transmission member 617a. More specifically, when viewed from the vertical direction (Z direction), at least a portion of the main body 660a of the brush 660 overlaps the transmission member 617a in the first axial direction.

Next, a configuration of the first conductive plate 662 will be described. As illustrated in FIG. 7, the first conductive plate 662 is a conductive member positioned upstream of the brush 660 in the first axial (Y) direction. As illustrated in FIG. 6B, a first hole 662d is formed in a portion of the first conductive plate 662, and the screw 665 passes through the first hole 662d. Thus, the first conductive plate 662 is secured to (supported by) the upper frame 64 with the screw 665. As illustrated in FIG. 7, the first conductive plate 662 includes a contact portion 662a, the contact portion 662b, and a contact portion 662c. The contact portion 662a is in contact with the resistance component 663, which will be described below. In other words, the first conductive plate 662 is electrically connected to the resistance component 663. As illustrated in FIGS. 7 and 8, the contact portion 662b is in contact with the base plate 660b. In other words, the contact portion 662b and the base plate 660b are electrically connected. Thus, the first conductive plate 662 is electrically connected to the brush 660 and the resistance component 663, which makes it possible for static electricity to flow from the brush 660 to the resistance component 663.

The grounding configuration according to the present embodiment includes the resistance component 663. By gradually discharging current to ground through the resistance component 663, a protective layer formed on a surface of the heater 611 is prevented from being damaged. As illustrated in FIG. 7, the resistance component 663 is pressed against the upper frame 64 by the contact portion 662a of the first conductive plate 662 and a contact portion 664a of the second conductive plate 664, secured to the upper frame 64, with the resistance component 663 having a predetermined electrical resistance.

The resistance component 663 is in contact with the contact portion 662a, and the resistance component 663 and the first conductive plate 662 are electrically connected. Further, the resistance component 663 is in contact with the contact portion 664a of the second conductive plate 664, which will be described below, and the resistance component 663 and the second conductive plate 664 are electrically connected. Thus, the resistance component 663 is electrically connected to the first conductive plate 662 and the second conductive plate 664, which allows static electricity to flow from the first conductive plate 662 toward the second conductive plate 664.

Next, a configuration of the second conductive plate 664 will be described. As illustrated in FIG. 6B, a second hole 664d is formed in the second conductive plate 664, and the screw 666 passes through the second hole 664d. Thus, the second conductive plate 664 is secured to the upper frame 64 with the screw 665.

As illustrated in FIG. 7, the second conductive plate 664 is a conductive member and includes contact portions 664a, 664b, and 664c. The contact portion 664a is in contact with the resistance component 663.

In other words, the resistance component 663 and the second conductive plate 664 are electrically connected. A third hole 664h is formed in the contact portion 664b. A hook 667a of the first conductive spring 667, which will be described below, passes through the third hole 664h and engages with the contact portion 664b. The contact portion 664b is in contact with the hook 667a of the first conductive spring 667, which will be described below. In other words, the second conductive plate 664 and the first conductive spring 667 are electrically connected. Thus, the second conductive plate 664 is electrically connected to the resistance component 663 and the first conductive spring 667, which allows static electricity to flow from the resistance component 663 toward the first conductive spring 667.

As illustrated in FIG. 7, the contact portion 664b includes an overlap portion 664bo, which overlaps the camshaft 671 when viewed from the vertical direction. The overlap portion 664bo is positioned below the camshaft 671. Since the second conductive plate 664 is positioned below the camshaft 671, the second conductive plate 664 is less likely to be obstructed by the rotation operation of the camshaft 671, compared to a configuration in which the second conductive plate 664 is positioned above the camshaft 671.

Further, the contact portion 664c is in contact with the camshaft 671 from above, with the contact portion 664c being a camshaft contact portion. This configuration allows electrical charge accumulated on the camshaft 671 to be discharged through the second conductive plate 664.

Next, a configuration of the first conductive spring 667 will be described. The first conductive spring 667 is a conductive member. As illustrated in FIG. 6B, the first conductive spring 667 includes a main body 667c, the hook 667a, and a hook 667b.

The hook 667a is one end of the first conductive spring 667, and the hook 667b is another end of the first conductive spring 667. As described above, the hook 667a engages with the contact portion 664b via the third hole 664h. The hook 667b engages with an upper hook 653a of the pressing spring 653, as described below. In other words, the first conductive spring 667 is in contact with the second conductive plate 664, and the pressing spring 653 and is electrically connected to the second conductive plate 664 via the first conductive spring 667. The main body 667c of the first conductive spring 667 extends from the hook 667a along the first axial (Y) direction and is connected to the hook 667b. In other words, the first conductive spring 667 (first spring) extends along the rotational axis direction of the pressing arm 652 (FIGS. 11C-12B) and is electrically connected to the pressing spring 653.

Next, a positional relationship between the main body 667c of the first conductive spring 667 and the frames will be described with reference to FIG. 6A. A groove shape 641c is formed in the supporting walls 64l of the upper frame 64. The groove shape 641c is configured to pass the main body 667c of the first conductive spring 667 from upstream to downstream in the first axial (Y) direction relative to the supporting walls 63l. The first conductive spring 667 passes through the groove shape 641c and extends along the first axial direction.

An end portion of each supporting wall 63l of the lower frame 63 in the recording material conveyance direction will be referred to as a support downstream end 631e. As illustrated in FIG. 6A, the support downstream end 631e is positioned between the camshaft 671 and the first conductive spring 667 in the recording material conveyance direction. The support downstream end 631e is brought into contact with the first conductive spring 667, thereby guiding the first conductive spring 667 to restrict movement of the first conductive spring 667 toward the camshaft 671. This configuration reduces the likelihood of interference with the first conductive spring 667 caused by the rotation of the camshaft 671. Although the first conductive spring 667 is configured to be in contact with the support downstream end 631e in the present embodiment, the first conductive spring 667 may be positioned further downstream of the support downstream end 631e in the recording material conveyance direction and may not be in contact with the support downstream end 631e.

Next, a conductive configuration of the pressing spring 653 will be described with reference to FIGS. 1A, 1B, 7, 12A, and FIG. 12B. The pressing spring 653 includes the upper hook 653a, a lower hook 653b, and a main body 653c of the pressing spring 653. One end of the pressing spring 653 is the upper hook 653a, and another end is the lower hook 653b. The main body 653c of the pressing spring 653 is connected to the upper hook 653a and the lower hook 653b and extends downward (vertical Z direction). In other words, the pressing spring 653 extends downward from the upper hook 653a toward the lower hook 653b. The upper hook 653a engages with the hook 667b of the first conductive spring 667. A hook 669b of a second conductive spring 669, which will be described below, engages with the lower hook 653b. Thus, the pressing spring 653 is in contact with the first conductive spring 667 and the second conductive spring 669, and is electrically connected to the first conductive spring 667 and the second conductive spring 669.

As illustrated in FIGS. 12A and 12B, the pressing arm 652 includes an engaged arm portion 652a, which is a grooved portion. The upper hook 653a is engaged with and supported by the engaged arm portion 652a. Thus, the pressing spring 653 is in contact with and supported by the pressing arm 652. The lower frame 63 includes an engaged frame portion 63e1, which is a grooved portion. The lower hook 653b is engaged with and supported by the engaged frame portion 63e1.

A conductive configuration of the second conductive spring 669 will be described with reference to FIGS. 1A and 1B. The second conductive spring 669 includes a hook 669a, the hook 669b, and a main body 669c. An end of the second conductive spring 669 is the hook 669a, and another end is the hook 669b. The main body 669c of the second conductive spring 669 is connected to the hooks 669a and 669b. The second conductive spring 669 extends from the hook 669a to the hook 669b along the recording material conveyance direction. The hook 669a engages with the contact spring 668, as described below. As described above, the hook 669b of the second conductive spring 669 engages with the lower hook 653b of the pressing spring 653. Thus, the second conductive spring 669 is in contact with the pressing spring 653 and the contact spring 668, and is electrically connected to the pressing spring 653 and the contact spring 668.

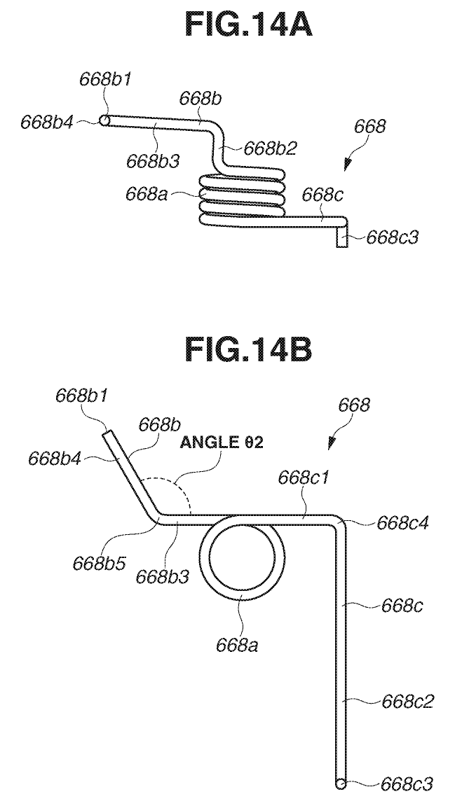

Next, a conductive configuration of the contact spring 668 will be described with reference to FIGS. 1A, 1B, 14A, and 14B. FIG. 14A is a front view illustrating the contact spring 668. FIG. 14B is a top view illustrating the contact spring 668.

The contact spring 668 is a torsion coil spring consisting of a single metal wire. The contact spring 668 includes a coil portion 668a, a first arm 668b extending from one end of the coil portion 668a toward the upstream side in the mounting direction, and a second arm 668c extending from another end toward the downstream side in the mounting direction. The coil portion 668a is wound around a boss 63e of the lower frame 63 and supported by the lower frame 63. In other words, the boss 63e is inserted into the coil portion 668a.

The first arm 668b includes a spring hook portion 668b2, an extended portion 668b3, a first-arm front end portion 668b4, and a bent portion 668b5, which is bent, and the front end of the first arm 668b includes the electrical contact point 668b1, which is in contact with a conductor portion 2A of the main body 2 of the image forming apparatus 1, which will be described below. The first-arm front end portion 668b4 is a front end portion of the first arm 668b. Further, the electrical contact point 668b1 can also be referred to as the front end of the first arm 668b. The electrical contact point 668b1 is brought into contact with the conductor portion 2A of the main body 2, thereby allowing static electricity to flow from the fixing apparatus 6 toward the main body 2 of the image forming apparatus 1.

The spring hook portion 668b2 extends from one end of the coil portion 668a along an axial direction of the coil portion 668a. The extended portion 668b3 is bent from the spring hook portion 668b2 and extends in a direction that intersects with the axial direction of the coil portion 668a. The first-arm front end portion 668b4 is bent from the extended portion 668b3 at the bent portion 668b5 and extends in a direction that is perpendicular to the axial direction of the coil portion 668a. The electrical contact point 668b1 is the front end of the first arm 668b, retains the cut shape of the metal wire, does not undergo a rounding treatment, and has a sharp edge.

Although the metal wire is illustrated as being cut neatly at a right angle in FIGS. 14A and 14B, the shape of the metal wire may be an irregular shape, such as a shape transferred from the shape of a blade of a cutting tool.

The second arm 668c includes a second extended portion 668c1, a third extended portion 668c2, a retention portion 668c3, and a pressed portion 668c4. The second extended portion 668c1 extends from another end of the coil portion 668a in the direction that intersects with the axial direction of the coil portion 668a. The pressed portion 668c4 is a portion that is bent from the second extended portion 668c1 toward the third extended portion 668c2. The third extended portion 668c2 extends in the direction that is perpendicular to the axial direction of the coil portion 668a and different from the second extended portion 668c1. The retention portion 668c3 extends from a far end portion of the third extended portion 668c2 from the coil portion 668a in the axial direction of the coil portion 668a.

The hook (one end) 669a of the second conductive spring 669 engages with the spring hook portion 668b2. The second conductive spring 669 is a tension spring. The hook (another end) 669b of the second conductive spring 669 engages with the lower hook 653b of the pressing spring 653. Consequently, as illustrated in FIG. 1B, the contact spring 668 is urged by the second conductive spring 669 so that the contact spring 668 rotates around an axis B of the boss 63e (an arrow C direction).

In a state where the fixing apparatus 6 is not mounted on the main body 2 of the image forming apparatus 1, the urging force from the second conductive spring 669 brings the bent portion 668b5 of the first arm 668b into contact with a contact surface 63f of the lower frame 63, and the orientation of the bent portion 668b5 is determined. Further, the lower frame 63 includes a first protective wall 63h and a second protective wall 63k. The first protective wall 63h is on one side of the first-arm front end portion 668b4 in an axis direction b of the coil portion 668a, and the second protective wall 63k is on another side of the first-arm front end portion 668b4. In other words, the first-arm front end portion 668b4 is positioned in a space between the first protective wall 63h and the second protective wall 63k. At this time, the electrical contact point 668b1 either does not protrude or protrudes slightly from the first protective wall 63h and the second protective wall 63k. Thus, in a state where the fixing apparatus 6 is not mounted on the main body 2 of the image forming apparatus 1, the electrical contact point 668b1 is protected by the first protective wall 63h and the second protective wall 63k and less likely to be caught by another object.

On the other hand, in a state where the fixing apparatus 6 is not mounted on the main body 2 of the image forming apparatus 1, the pressed portion 668c4 is bent so that the pressed portion 668c4 protrudes from the lower frame 63. The lower frame 63 includes a slit 63g (FIG. 1B) and a retention wall 63n (FIG. 1B) positioned downstream of the boss 63e in the opposite direction to the recording material conveyance direction. The slit 63g extends in a direction that is perpendicular to an axis of the boss 63e. More specifically, the slit 63g extends in the recording material conveyance direction. The retention wall 63n is positioned adjacent to the slit 63g. The third extended portion 668c2 of the second arm 668c is inserted into the slit 63g. The retention portion 668c3 is positioned upstream of the retention wall 63n in the first axial direction and faces the retention wall 63n. Thus, in a case where the second conductive spring 669 rotates in an arrow c direction (FIG. 1B), which corresponds to the direction in which the pressed portion 668c4 protrudes, the retention portion 668c3 is brought into contact with the retention wall 63n.

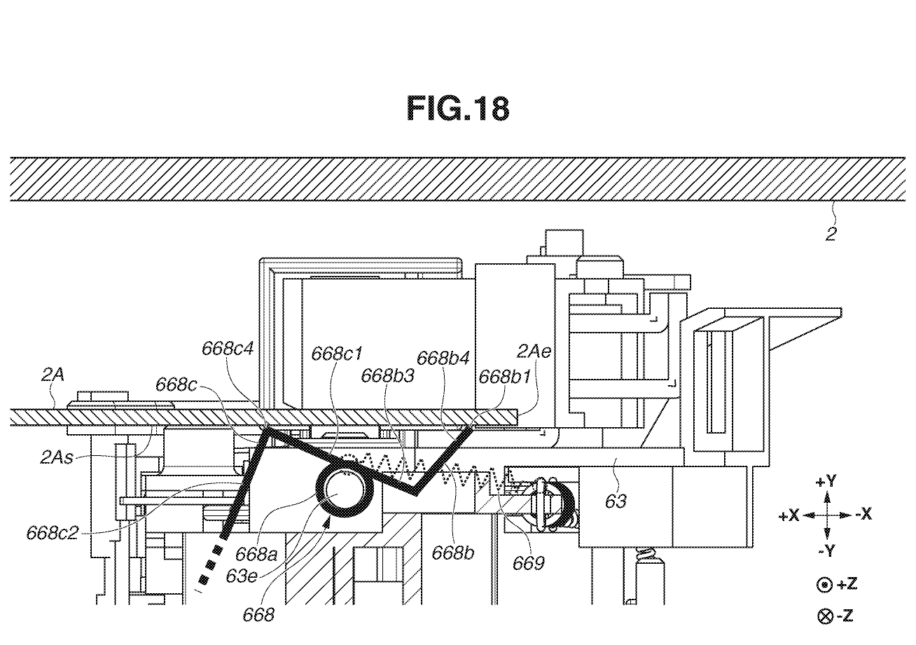

Next, a conductive configuration of the main body 2 of the image forming apparatus 1 will be described with reference to FIG. 18. FIG. 18 is a top view illustrating the fixing apparatus 6 and illustrates a state where the fixing apparatus 6 is mounted on the main body 2 of the image forming apparatus 1. The main body 2 of the image forming apparatus 1 includes the conductor portion 2A of the main body 2, which is conductive. The conductor portion 2A of the main body 2 according to the present embodiment is an electrode. The contact spring 668 is positioned closer to the longitudinal center of the heating unit 61 than the conductor portion 2A of the main body 2.

The conductor portion 2A of the main body 2 is a metal plate, which may also serve as a frame of the main body 2 of the image forming apparatus 1. The conductor portion 2A of the main body 2 is configured to be electrically grounded. The conductor portion 2A of the main body 2 includes a contact surface 2As, and the contact surface 2As constitutes an end portion of the conductor portion 2A of the main body 2 on the first direction side and extends in the mounting direction (+X direction). The contact surface 2As is in contact with the electrical contact point 668b1 and electrically connected to the electrical contact point 668b1. Thus, the conductor portion 2A of the main body 2 can discharge static electricity from the electrical contact point 668b1 to ground.

As described above, the main body 660a of the brush 660 is in contact with the front surface 614b of the belt 614 and electrically connected to the belt 614. The brush 660 is in contact with the first conductive plate 662 and electrically connected to the first conductive plate 662. The resistance component 663 is in contact with the second conductive plate 664 and electrically connected to the second conductive plate 664. The second conductive plate 664 is in contact with the first conductive spring 667 and electrically connected to the first conductive spring 667. The first conductive spring 667 is in contact with the pressing spring 653 and electrically connected to the pressing spring 653. The pressing spring 653 is in contact with the second conductive spring 669 and electrically connected to the second conductive spring 669. The second conductive spring 669 is in contact with the contact spring 668 and electrically connected to the contact spring 668. The electrical contact point 668b1 of the contact spring 668 is in contact with the conductor portion 2A of the main body 2 of the image forming apparatus 1 and electrically connected to the conductor portion 2A. The conductor portion 2A of the main body 2 is configured to be electrically grounded.

The first conductive plate 662, the resistance component 663, the second conductive plate 664, and the pressing spring 653 may collectively be referred to as first conductor portion 600a. In other words, the first conductor portion 600a includes the first conductive plate 662, the resistance component 663, the second conductive plate 664, and the first conductive spring 667.

The first conductor portion 600a is in contact with the brush 660 and includes the pressing spring 653, the brush 660 and the pressing spring 653 being electrically connected.

The second conductive spring 669 and the contact spring 668 may collectively be referred to as second conductor portion 600b. In other words, the second conductor portion 600b includes the second conductive spring 669 and the contact spring 668. The second conductor portion 600b is in contact with the pressing spring 653 and the conductor portion 2A of the main body 2 and electrically connect the pressing spring 653 and the conductor portion 2A of the main body 2.

Thus, electrical charge generated in the heating unit 61 is grounded through the brush 660, the first conductor portion 600a, and the second conductor portion 600b. With this configuration, electrical charge in the heating unit 61 can be removed.

Since the upper frame 64 and the lower frame 63 of the fixing apparatus 6 according to the present embodiment are made of resin, it is difficult to use the upper frame 64 and the lower frame 63 as a portion of the grounding configuration. However, as described above, the electrical connection to the conductor portion 2A of the main body 2 via the brush 660, the first conductor portion 600a, and the second conductor portion 600b makes it possible to release electrical charge generated in the heating unit 61.

The upper frame 64 (second frame) of the fixing apparatus 6 according to the present embodiment supports the first conductive plate 662, the resistance component 663, and the second conductive plate 664. In other words, the upper frame 64 supports the first conductor portion 600a. Thus, the upper frame 64 guides the first conductor portion 600a. Supporting the first conductor portion 600a with the upper frame 64, as described above, increases the stability of the first conductor portion 600a against external forces.

### Mounting the Fixing Device in the Main Body of the Image Forming Apparatus

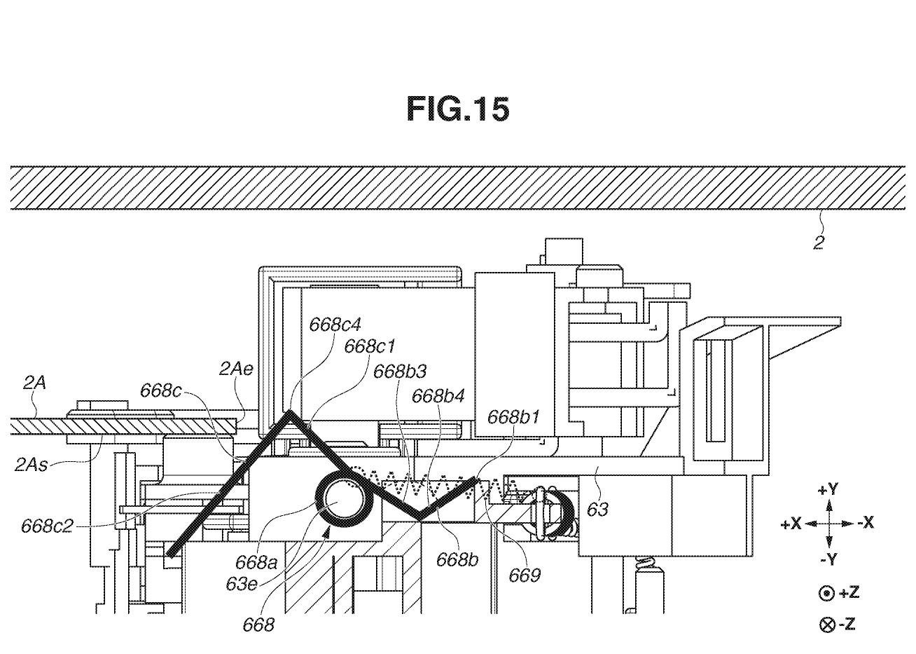

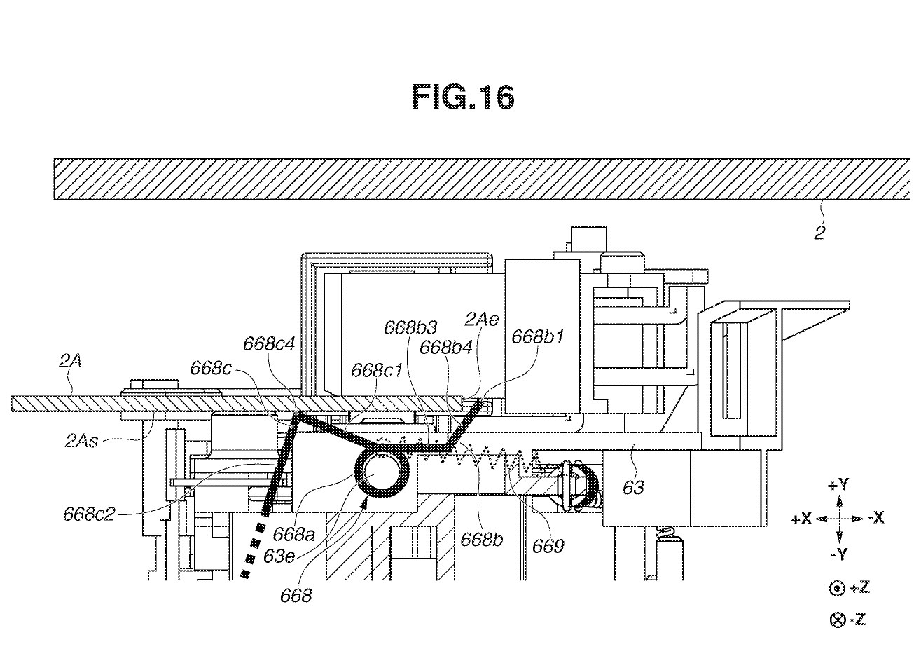

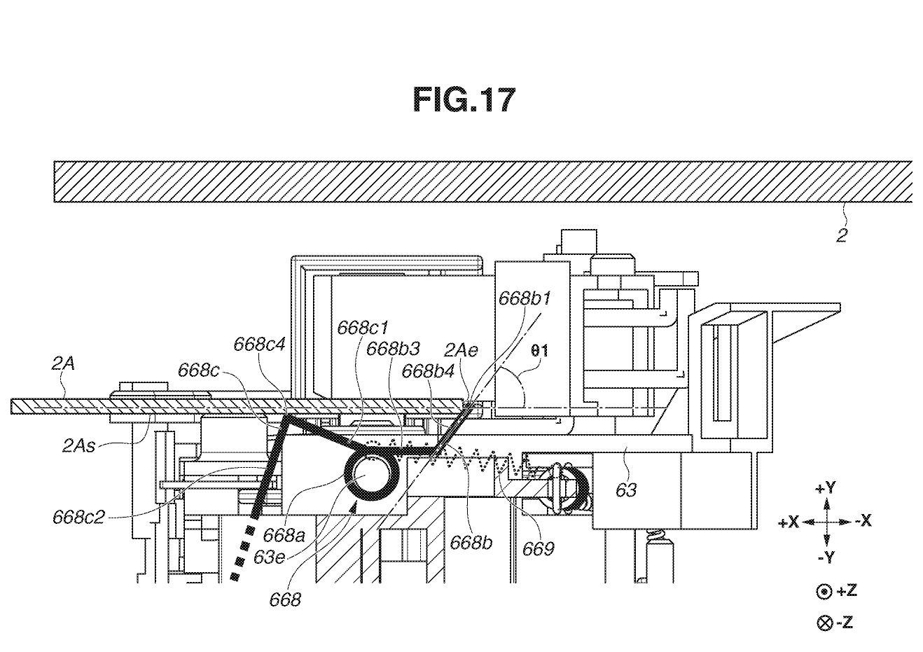

Next, an operation of the contact spring 668 during a mounting process of moving the fixing apparatus 6 to a mounting position and mounting the fixing apparatus 6 in the main body 2 of the image forming apparatus 1 will be described. The fixing apparatus 6 is moved in the mounting direction (+X direction) relative to the main body 2 of the image forming apparatus 1 and mounted at the mounting position. FIG. 15 is a top view illustrating a state before the fixing apparatus 6 is mounted on the main body 2 of the image forming apparatus 1. FIG. 16 is a top view illustrating a state where the fixing apparatus 6 is inserted further into the main body 2 of the image forming apparatus 1 from FIG. 15. FIG. 17 is a top view illustrating a state where the fixing apparatus 6 is inserted still further into the main body 2 of the image forming apparatus 1 from FIG. 16. FIG. 18 is a top view illustrating a state where the fixing apparatus 6 is inserted yet further into the main body 2 of the image forming apparatus 1 from FIG. 17, and mounted on the main body 2 of the image forming apparatus 1 at the mounting position.

As illustrated in FIG. 15, the conductor portion 2A of the main body 2 includes an upstream end 2Ae of the main body 2. The upstream end 2Ae is an end portion of the conductor portion 2A of the main body 2 on the upstream side in the mounting direction. The upstream end 2Ae of the main body 2 extends in the first direction (-Y direction). An end portion of the upstream end 2Ae of the main body 2 on a first-direction side is connected to an end portion of the contact surface 2As on the side in the opposite direction (-X direction) to the mounting direction.

The position of the contact spring 668 before the fixing apparatus 6 is mounted will be described. As illustrated in FIG. 15, in the state before the fixing apparatus 6 is mounted, the electrical contact point 668b1 and the pressed portion 668c4 are positioned upstream of the upstream end 2Ae of the main body 2 in the mounting direction. Further, the pressed portion 668c4 is positioned upstream of the contact surface 2As in the first direction. Further, the position of a portion of the third extended portion 668c2 corresponds to the position of the upstream end 2Ae of the main body 2 in the first direction. Further, the electrical contact point 668b1 is positioned downstream of the upstream end 2Ae of the main body 2 in the first direction.

In a case where the fixing apparatus 6 illustrated in FIG. 15 moves in the mounting direction relative to the main body 2 of the image forming apparatus 1, the third extended portion 668c2 and the upstream end 2Ae of the main body 2 are brought into contact with each other. Since the third extended portion 668c2 is configured to extend in the first direction, the third extended portion 668c2 is pressed by the upstream end 2Ae of the main body 2 as the third extended portion 668c2 is moved toward the mounting direction, and the second arm 668c rotates counterclockwise around the boss 63e. Thus, as the third extended portion 668c2 moves in the mounting direction, the second arm 668c is brought into contact with the upstream end 2Ae of the main body 2 and moves in the –Y direction while being pressed, and the pressed portion 668c4 is brought into contact with the contact surface 2As (FIG. 16). The counterclockwise rotation of the second arm 668c causes the coil portion 668a and the first arm 668b to rotate counterclockwise around the boss 63e. Consequently, as illustrated in FIG. 16, the first-arm front end portion 668b4 is positioned at the same position as that of the upstream end 2Ae of the main body 2 in the first direction while the pressed portion 668c4 is in contact with the contact surface 2As. In a case where the fixing apparatus 6 moves further in the mounting direction relative to the main body 2 of the image forming apparatus 1 from the state illustrated in FIG. 16, the first-arm front end portion 668b4 is brought into contact with the upstream end 2Ae of the main body 2, as illustrated in FIG. 17. In other words, as the second arm 668c is brought into contact with the conductor portion 2A of the main body 2 and moves in the first direction, the first-arm front end portion 668b4 (front end portion) moves in the second direction opposite to the first direction and is brought into contact with the upstream end 2Ae of the main body 2.

FIG. 17 illustrates a state when the first-arm front end portion 668b4 (front end portion) starts making contact with the upstream end 2Ae of the main body 2. The first-arm front end portion 668b4 (front end portion) is configured to extend in the first direction as the first-arm front end portion 668b4 is moved in the mounting direction when the first-arm front end portion 668b4 starts making contact with the upstream end 2Ae of the main body 2. FIG. 17 illustrates a state when the first-arm front end portion 668b4 starts making contact with the upstream end 2Ae of the main body 2. An angle θ1 formed between the direction in which the first-arm front end portion 668b4 extends and the mounting direction is an acute angle (less than or equal to 90 degrees). In a case where, for example, the formed angle θ1 is an obtuse angle (greater than or equal to 90 degrees), the contact spring 668 and the upstream end 2Ae of the main body 2 may interfere with each other, and the contact spring 668 may be deformed. Thus, according to the present disclosure, the formed angle θ1 is configured to be an acute angle, thereby making the contact spring 668 less prone to deformation. The formed angle θ1 can be set so that 30 degrees ≧ θ > 0 degrees, considering that the contact spring 668 may be deformed in a case where the formed angle θ1 is greater than or equal to a predetermined angle.

According to the present embodiment, as a method for configuring the formed angle θ1 to be an acute angle, an angle θ2 formed by the extended portion 668b3 and the first-arm front end portion 668b4 is configured to be an obtuse angle (greater than or equal to 90 degrees), as illustrated in FIG. 14. In other words, the formed angle θ2 is an angle at which the bent portion 668b5 (first bent portion) is bent. Configuring the formed angle θ2 to be an obtuse angle as described above makes it easier to configure the formed angle θ1 to be an acute angle, which can reduce deformation of the contact spring 668. Further, according to the present embodiment, the formed angle θ2 is set within the range of 135 degrees ± 20 degrees (155 degrees ≧ θ2 ≧ 115 degrees). In a case where the contact spring 668 is manufactured so that the formed angle θ2 is less than or equal to 115 degrees, there is a probability that the formed angle θ2 may become less than or equal to 90 degrees due to manufacturing variation. As described above, in a case where the formed angle θ1 is an obtuse angle (greater than or equal to 90 degrees), the contact spring 668 and the upstream end 2Ae of the main body 2 may interfere with each other, and the contact spring 668 may be deformed. Thus, according to the present embodiment, θ2 ≧ 115 degrees. Further, it may be difficult to manufacture the contact spring 668 so that the formed angle θ2 becomes greater than or equal to 155 degrees. Thus, according to the present embodiment, 155 degrees ≧ θ2 considering the ease of manufacturing the contact spring 668.

In a case where the fixing apparatus 6 moves further in the mounting direction relative to the main body 2 of the image forming apparatus 1 from the state illustrated in FIG. 17, the first-arm front end portion 668b4 moves in the first direction while being in contact with the upstream end 2Ae of the main body 2 and moving in the mounting direction. Consequently, the electrical contact point 668b1 (front end) is guided to the contact surface 2As and brought into contact with the contact surface 2As. Furthermore, in a case where the fixing apparatus 6 moves in the mounting direction, the sharp edge of the electrical contact point 668b1 moves while scratching the contact surface 2As. Thus, even in a case where films exist, e.g., a coating film and/or an oxide film on the contact surface 2As, the electrical contact point 668b1 scrapes off the films, thereby maintaining the electrical connection between the conductor portion 2A of the main body 2 and the electrical contact point 668b1. Ultimately, the fixing apparatus 6 is mounted at the mounting position, as illustrated in FIG. 18.

### Second Embodiment

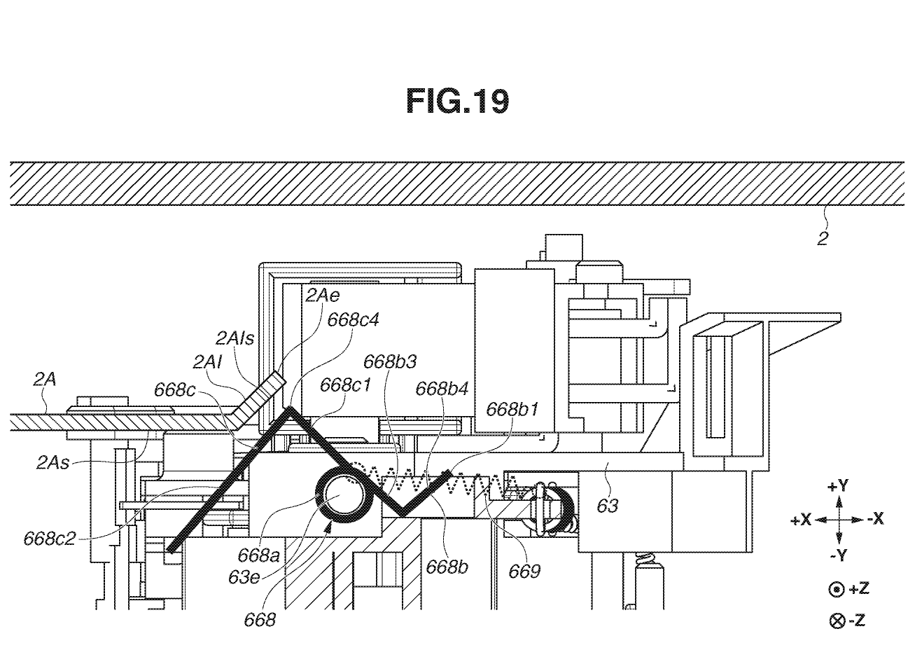

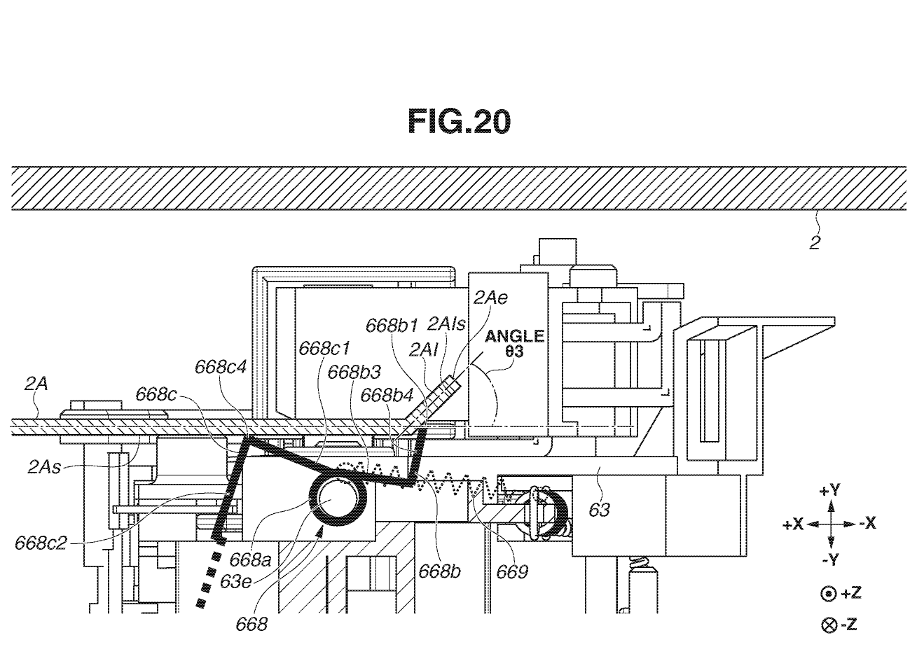

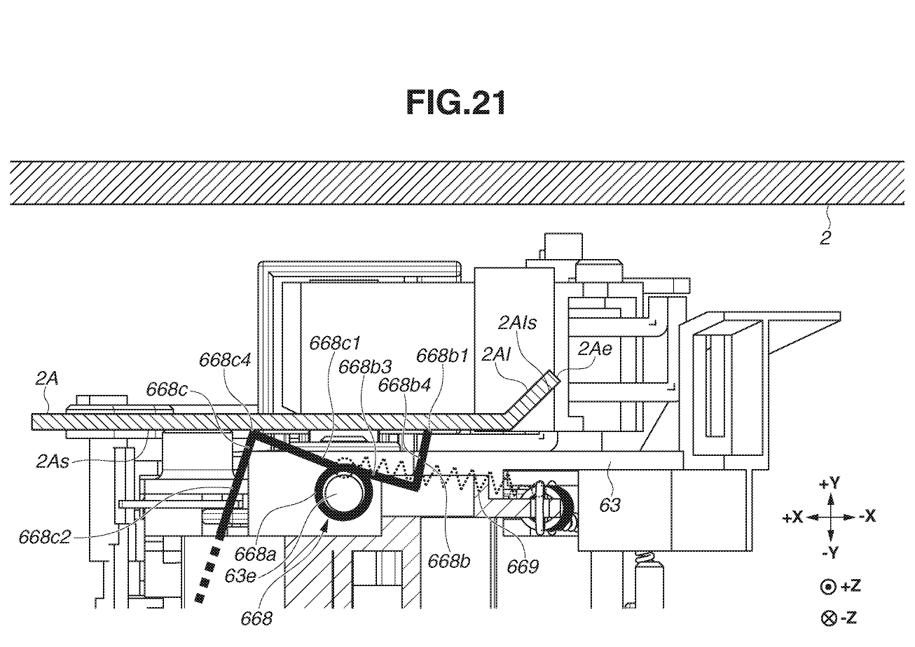

A second embodiment will be described. The present embodiment differs from the first embodiment in that the conductor portion 2A of the main body 2 includes a guiding portion to reduce interference between the first-arm front end portion 668b4 and the conductor portion 2A of the main body 2. FIG. 19 is a top view illustrating a state before the fixing apparatus 6 is mounted on the main body 2 of the image forming apparatus 1. FIG. 20 is a top view illustrating a state where the fixing apparatus 6 is inserted further into the main body 2 of the image forming apparatus 1 from the state in FIG. 19. FIG. 21 is a top view illustrating a state where the fixing apparatus 6 is inserted still further into the main body 2 of the image forming apparatus 1 from the state in FIG. 20 and mounted on the main body 2 of the image forming apparatus 1 at the mounting position. As illustrated in FIG. 19, the conductor portion 2A of the main body 2 includes a guiding portion 2AI. The guiding portion 2AI is configured to guide the first-arm front end portion 668b4 to the contact surface 2As. The guiding portion 2AI includes a guiding surface 2AIsthat extends in the first direction as the guiding surface 2A in the mounting direction and connects to the contact surface 2As. In a case where the fixing apparatus 6 moves in the mounting direction from the state in FIG. 19, the pressed portion 668c4 is guided while being pressed by the guiding surface 2AIs and is guided to the contact surface 2As. In other words, the second arm 668c is guided by the guiding surface 2AIs and moves in the first direction. The counterclockwise rotation of the second arm 668c causes the coil portion 668a and the first arm 668b to rotate counterclockwise around the boss 63e. In other words, the first-arm front end portion 668b4 is configured so that as the second arm 668c moves in the first direction, the first-arm front end portion 668b4 moves in the second direction opposite to the first direction and is brought into contact with the guiding surface 2AIs (guide portion).

FIG. 20 illustrates a state of the fixing apparatus 6 when the first-arm front end portion 668b4 starts making contact with the guiding surface 2AIs. As described above, the guiding surface 2AIs extends in the first direction toward the mounting direction, and an angle θ3 is formed between the mounting direction and the guiding surface 2AIs as an acute angle. This guides the first-arm front end portion 668b4 in the first direction, thereby reducing interference between the first-arm front end portion 668b4 and the conductor portion 2A of the main body 2. The formed angle θ3 can be less than or equal to 30 degrees and greater than 0 degrees considering that the contact spring 668 may be deformed in a case where the formed angle θ3 is greater than or equal to a predetermined angle.

In a case where the fixing apparatus 6 is inserted further into the main body 2 of the image forming apparatus 1 from the state in FIG. 20, the first-arm front end portion 668b4 is guided by the guiding surface 2AIs, thereby moving in the first direction while moving in the mounting direction. Furthermore, the electrical contact point 668b1 (front end) is guided to the contact surface 2As. The electrical contact point 668b1 moves in the mounting direction while being in contact with the contact surface 2As, and the fixing apparatus 6 is ultimately mounted on the main body 2 of the image forming apparatus 1 at the mounting position, as illustrated in FIG. 21.

As described above, according to the second embodiment, the guiding surface 2AIs is configured to guide the first-arm front end portion 668b4 to the contact surface 2As, thereby reducing the probability of deformation of the contact spring 668.

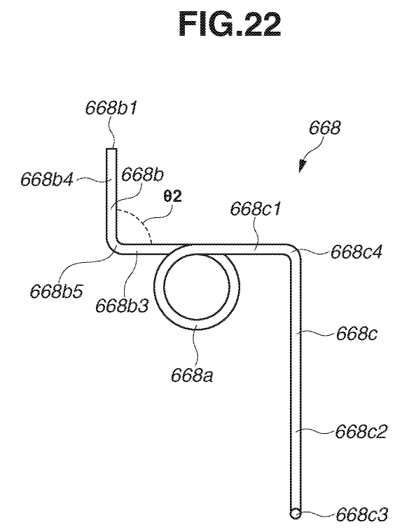

Although the formed angle θ2 is an obtuse angle according to the first embodiment, in a case where the formed angle θ1 is configured to be an acute angle, the formed angle θ2 may be less than or equal to an acute angle (90 degrees), as illustrated in FIG. 22. Configuring the formed angle θ2 to be less than or equal to 90 degrees ± 10 degrees makes it possible to further increase the contact pressure of the electrical contact point 668b1 against the contact surface 2As, compared to where the formed angle θ2 is an obtuse angle. Further, in a case where the contact spring 668 is manufactured so that the formed angle θ2 is less than or equal to 90 degrees ± 10 degrees, the manufacturing is easier compared to a case where the formed angle θ2 is an extremely obtuse or acute angle.

Although the guiding portion 2AI is the conductor portion 2A of the main body 2 according to the second embodiment, the guiding portion 2AI and the conductor portion 2A may be configured as separate portions. Further, the shape of the guiding portion 2AI may be a hemmed or curled shape.

The disclosure of the present embodiment includes at least the following configuration.

Thus, provided is an image forming apparatus including a main body with a main-body conductor portion configured to be grounded and a fixing apparatus. The fixing apparatus is configured to mount on the main body by moving the fixing apparatus in a mounting direction relative to the main body to a mounting position. The fixing apparatus includes a heating unit including a belt and a heater configured to heat an inner surface of the belt, with a longitudinal direction of the heating unit intersecting with the mounting direction. The fixing apparatus also includes a conductive torsion coil spring including a first arm extending from a first side and a second arm extending from an opposite side thereof, the conductive torsion coil spring being electrically connected to the heating unit. The fixing apparatus further includes a frame configured to support the heating unit and the coil portion. A front end portion of the first arm is configured to contact a contact surface of the main-body conductor portion. The main-body conductor portion includes an upstream end connected to the contact surface along the mounting direction.

The present disclosure makes it possible to provide a fixing apparatus of a new type based on conventional technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-190141, filed October 29, 2024, which is hereby incorporated by reference herein in its entirety.

What is claimed is:

1. An image forming apparatus comprising:
a main body including a main-body conductor portion configured to be grounded; and
a fixing apparatus configured to mount on the main body by moving the fixing apparatus in a mounting direction relative to the main body to a mounting position,
wherein the fixing apparatus includes:
a heating unit including a belt and a heater configured to heat an inner surface of the belt, with a longitudinal direction of the heating unit intersecting with the mounting direction;
a pressing roller configured to form a nip together with the heater via the belt;
a conductive torsion coil spring including a coil portion, a first arm extending from the coil portion to an upstream side in the mounting direction, and a second arm extending from the coil portion to a downstream side in the mounting direction, the conductive torsion coil spring being electrically connected to the heating unit; and
a frame configured to support the heating unit and the coil portion,
wherein the torsion coil spring is positioned closer to a longitudinal center of the heating unit than the main-body conductor portion is,
wherein a front end of a front end portion of the first arm is configured to contact a contact surface of the main-body conductor portion,
wherein the main-body conductor portion includes an upstream end connected to the contact surface along the mounting direction,
wherein the longitudinal direction extending from the conductive torsion coil spring to a longitudinal center of the heating unit is a first direction, and a direction opposite to the first direction is a second direction,
wherein, in response to moving the fixing apparatus toward the mounting position, the second arm is pressed by the upstream end, and move in the first direction wherein the first arm is configured to move in the second direction so that the front end portion is brought into contact with the upstream end, when the second arm moves in the first direction, and
wherein, when the front end portion initiates contact with the upstream end, the front end portion is configured to extend in the first direction as the front end portion is toward the mounting direction, and
wherein, after contacting the upstream end, the front end portion is configured to be guided toward the contact surface and moved in the mounting direction while contacting the contact surface as the fixing apparatus moves toward the mounting position.

2. An image forming apparatus comprising:
a main body including a main-body conductor portion configured to be grounded; and
a fixing apparatus configured to mount on the main body by moving the fixing apparatus in a mounting direction relative to the main body to a mounting position,
wherein the fixing apparatus includes:
a heating unit including a belt and a heater configured to heat an inner surface of the belt, with a longitudinal direction of the heating unit intersecting with the mounting direction;
a pressing roller configured to form a nip together with the heater via the belt;
a conductive torsion coil spring including a coil portion, a first arm extending from the coil portion to an upstream side in the mounting direction, and a second arm extending from the coil portion to a downstream side in the mounting direction, the conductive torsion coil spring being electrically connected to the heating unit; and
a frame configured to support the heating unit and the coil portion,
wherein the torsion coil spring is positioned closer to a longitudinal center of the heating unit than the main-body conductor portion is,
wherein a front end of a front end portion of the first arm is configured to contact a contact surface of the main-body conductor portion,
wherein the longitudinal direction extending from the conductive torsion coil spring to a longitudinal center of the heating unit is a first direction, and a direction opposite to the first direction is a second direction,
wherein the main-body conductor portion includes a guide portionconfigured to extend in the first direction as the guide portion is toward the mounting direction, the guide portion being connected to the contact surface,
wherein, in response to moving the fixing apparatus toward the mounting position, the second arm is pressed by the guide portion and move in the first direction,
wherein the first arm is configured to move in the second direction so that the front end portion is brought into contact with the guide portion when the second arm moves in the first direction, and
wherein, after contacting the upstream end, the front end portion is configured to be guided toward the contact surface and moved in the mounting direction while contacting the contact surface as the fixing apparatus moves toward the mounting position.

3. The image forming apparatus according to claim 1, wherein the frame includes a boss configured to be inserted into the coil portion.

4. The image forming apparatus according to claim 2, wherein the frame includes a boss configured to be inserted into the coil portion.

5. The image forming apparatus according to claim 1, wherein the frame is made of resin.

6. The image forming apparatus according to claim 2, wherein the frame is made of resin.

7. The image forming apparatus according to claim 1, wherein the belt includes a conductive layer, the image forming apparatus further comprising:
a pressing arm configured to press the heating unit against the pressing roller;
a pressing spring having conductivity and configured to urge the pressing arm in a direction in which the pressing arm presses the heating unit;
a brush member having conductivity and configured to be brought into contact with the belt;
a first conductor portion configured to electrically connect the brush member to the pressing spring; and
a second conductor portion configured to electrically connect the pressing spring to the conductive torsion coil spring.

8. The image forming apparatus according to claim 2, wherein the belt includes a conductive layer,
the image forming apparatus further comprising:
a pressing arm configured to press the heating unit against the pressing roller;
a pressing spring having conductivity and configured to urge the pressing arm in a direction in which the pressing arm presses the heating unit;
a brush member having conductivity and configured to be brought into contact with the belt;
a first conductor portion configured to electrically connect the brush member to the pressing spring; and
a second conductor portion configured to electrically connect the pressing spring to the torsion coil spring.

9. The image forming apparatus according to claim 8,
wherein the second conductor portion includes a conductive spring,
wherein an end of the conductive spring is in contact with an end of the pressing spring and another end is in contact with the first arm, and
wherein the conductive spring urges the first arm against the frame.

10. The image forming apparatus according to claim 7, wherein the first conductor portion is connected to a resistance component.

11. The image forming apparatus according to claim 1,
wherein the first arm is bent at a first bent portion, and
wherein a bending angle of the first bent portion is greater than or equal to 115 degrees and less than or equal to 155 degrees.

12. The image forming apparatus according to claim 2,
wherein the first arm is bent at a first bent portion, and
wherein a bending angle of the first bent portion is greater than or equal to 115 degrees and less than or equal to 155 degrees.

13. The image forming apparatus according to claim 1, wherein an angle formed by a direction in which the front end extends and the mounting direction when the front end starts making contact with the main-body upstream end is less than or equal to 30 degrees and greater than 0 degrees.

14. The image forming apparatus according to claim 2, wherein an angle formed by a direction in which the guide portion extends and the mounting direction is less than or equal to 30 degrees and greater than 0 degrees.

15. A method for mounting a fixing apparatus,
the fixing apparatus including:
a heating unit including a belt and a heater configured to heat an inner surface of the belt, with a longitudinal direction of the heating unit intersecting with a mounting direction;
a conductive torsion coil spring including a coil portion, a first arm extending from the coil portion to an upstream side in the mounting direction, and a second arm extending from the coil portion to a downstream side in the mounting direction, the conductive torsion coil spring being electrically connected to the heating unit; and
a frame configured to support the heating unit and the coil portion,
wherein the first arm includes a front end portion,
wherein a main body of an image forming apparatus includes a main-body conductor portion configured to be grounded,
wherein the main-body conductor portion includes a contact surface and an upstream end connected to the contact surface, and
wherein the longitudinal direction extending from the conductive torsion coil spring to a longitudinal center of the heating unit is a first direction, and a direction opposite to the first direction is a second direction,
the method comprising:
moving the fixing apparatus in the mounting direction relative to the main body to cause the second arm to be pressed by the upstream end and move in the first direction, and move the first arm in the second direction as the second arm moves in the first direction;
bringing the front end portion into contact with the upstream end as the front end portion extends in the first direction; and
guiding the front end portion toward the contact surface, and moving the front end in the mounting direction while being in contact with the contact surface.
